(19) United States
(12) Patent Application Publication
(10) Pub. No.: US 2024/0425095 A1
(43) Pub. Date: Dec. 26, 2024

(54) Wheelbarrow Drive Unit

(71) Applicant: Craig E. Bohn, Seattle, WA (US)

(72) Inventor: Craig E. Bohn, Seattle, WA (US)

(21) Appl. No.: 18/754,805

(22) Filed: Jun. 26, 2024

Related U.S. Application Data
(60) Provisional application No. 63/523,363, filed on Jun. 26, 2023.

(51) Int. Cl. B62B 5/00; B62B 1/18

(52) U.S. Cl. CPC B62B 5/005; B62B 5/0043; B62B 5/0053; B62B 5/0069; B62B 1/18

(57) ABSTRACT

A power drive unit attachable to a wheelbarrow to apply rotational force to the wheelbarrow wheel, the drive unit comprising a drive motor to power a drive wheel, with the drive wheel extending outward from the drive unit frame to be contactable with a wheelbarrow wheel, and a battery receiver to the drive motor for receiving one or more batteries, to include the type of batteries used in cordless tools.

### CROSS-REFERENCE TO RELATED APPLICATIONS

This application claims the benefit of U.S. Application No. 63/523,363, filed on Jun. 26, 2023, by the present inventor, entitled “Wheelbarrow Drive Unit,” which is hereby incorporated by reference in its entirety for all allowable purposes, including the incorporation and preservation of any and all rights to the patentable subject matter of the inventor, such as features, elements, processes and process steps, and improvements that may supplement or relate to the subject matter described herein.

### BACKGROUND OF THE INVENTION

This innovation relates generally to power units for a wheelbarrow, and more specifically to a battery-powered, drive unit that is selectively attachable to a wheelbarrow frame to impart rotational force through direct contact with a wheelbarrow wheel.

Job sites presently use a variety of cordless power tools. Current cordless systems permit the interchange of modular battery units so that the various tools may each receive power from a collection of interchangeable, rechargeable batteries. It would be an improvement to the field of art to have a power drive unit, powerable by an interchangeable, rechargeable battery, removable mountable to a wheelbarrow frame to impart rotational force to the wheel of the wheelbarrow, to assist in the locomotion of heavy loads.

### BRIEF DESCRIPTION OF THE DRAWINGS

FIG. 1 is a schematic side view of an exemplary drive unit attached to a wheelbarrow, according to the present invention.

FIG. 2 is a schematic front view of an exemplary drive unit superimposed over an image of a wheelbarrow, according to the present invention.

### DESCRIPTION OF THE PREFERRED EMBODIMENT

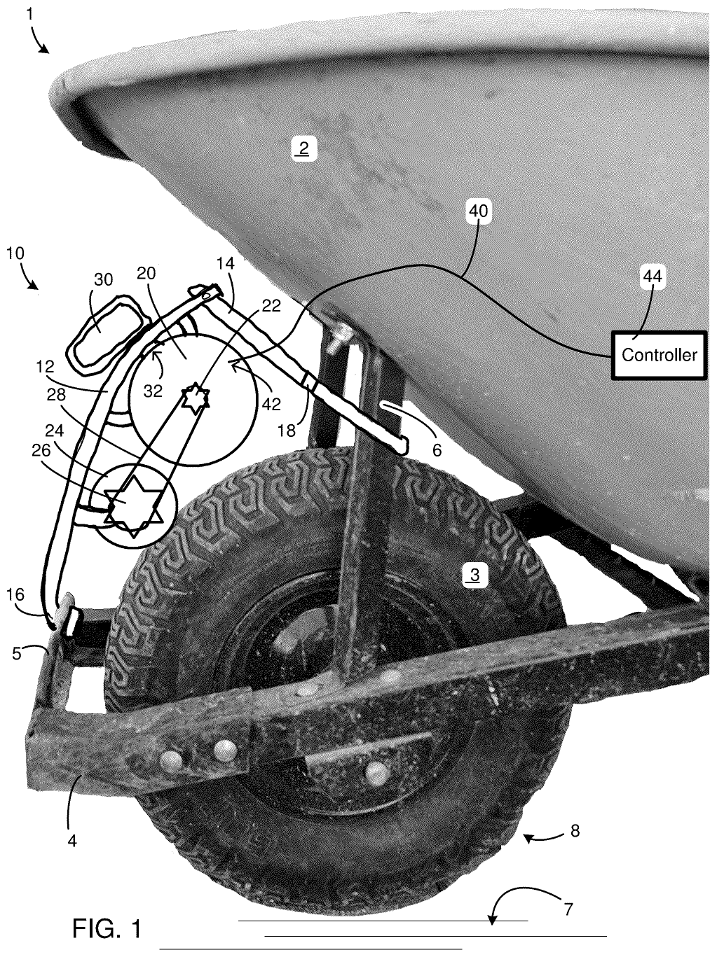

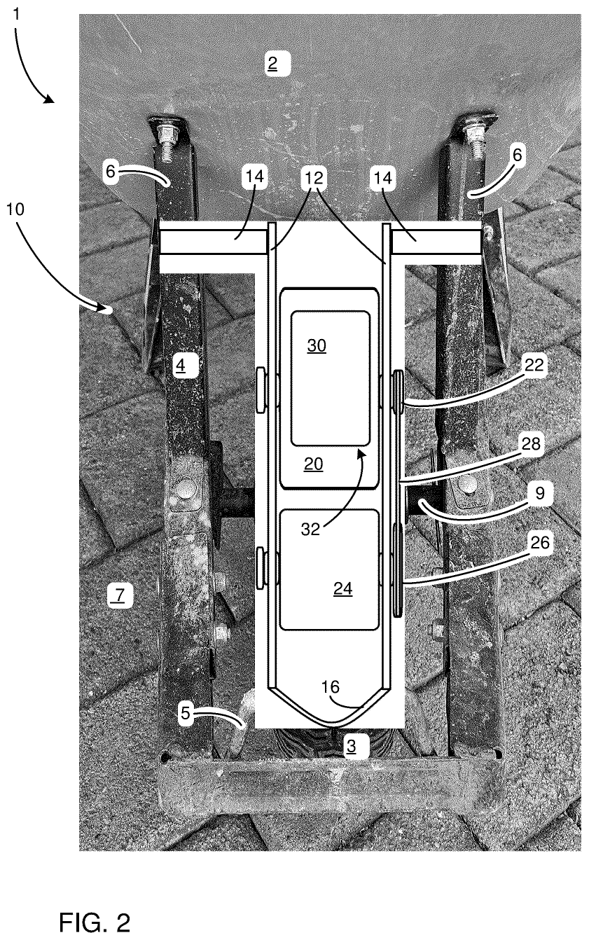

Referring now to FIGS. 1 and 2, the present exemplary drive unit 10 is shown secured to a wheelbarrow 1. An exemplary wheelbarrow 1 may have a bucket 2, and a wheel 3 secured to the bucket by a housing 4. Since housing 4 secures the axle 9 of the wheel 3, and provides a support structure within which the wheel 3 may rotate about the axis of the axle, the housing 4 may also be referred to as a frame 4. The housing 4 may have a front lift point 5 and at least one upright support 6. The upright support 6 may keep the bucket 2 from directly contacting the wheel 3 or a surface 7. The surface 7 may be generally referred to as the ground.

Wheel 3 may support the balance of the wheelbarrow 1 on a surface 7. The wheel 3 has a circumferential working surface 8 intended for contact with a surface 7. The wheel 3 may have a forward direction and a rearward direction. The forward direction being in the direction that the wheel 3 would move when rotated in a first rotational direction about the axis of the axle 9 while in contact with a surface 7, and the rearward direction that the wheel 3 would move when rotated in a second rotational direction about the axis of the axel 9 while in contact with a surface 7. The second rotational direction being opposite the first rotational direction. With the wheel 3 moving in the forward direction while in contact with the surface 7, the wheelbarrow 1 also may be said to move in the forward direction. With the wheel 3 moving in the rearward direction while in contact with the surface 7, the wheelbarrow 1 also may be said to move in the rearward direction. The housing 4 may be seen to have a rear or rear side and a front or front side corresponding to a rearward and a forward direction, respectively, of the wheel 3. A portion of the wheelbarrow 1 that leads in the forward direction may be referred to as the front, and the portion of the wheelbarrow 1 that trails in the forward direction may be referred to as the rear.

In general terms, a wheel 3 may be mounted for rotation around an axle 9 in a housing 4. The housing may have a rear side and a front side, corresponding to the rearward and forward direction of the wheel 3, respectively. Either or both the rear side and the front side may have an attachment point on the housing 4, which may be on the front lift point 5 and an upright support 6. Each attachment point provides for a relative set distance from the working surface 8 of the wheel 3.

In an exemplary embodiment, a drive unit 10 may have a drive unit frame 12 onto which may be secured a motor 20 and a drive wheel 24. (The drive unit frame 12 may be hereinafter referred to as a DU frame 12, to avoid confusion with the wheelbarrow frame 4.) In an exemplary embodiment, the drive wheel 24 may be mounted to the DU frame 12 so as to permit rotation of the drive wheel 24. The drive wheel 24 may extend outward from the DU frame to be contactable with a wheel 3. In an exemplary embodiment, the motor 20 may be configured to impart rotational force to drive sprocket 22. In an exemplary embodiment, drive wheel 24 may be functionally attached to a driven sprocket 26 such that rotation of the driven sprocket 26 may impart rotation in the drive wheel 24. A continuous belt 28 may connect the drive sprocket 22 with the driven sprocket 26 to provide for the transfer of rotational force from the drive sprocket 22 to the driven sprocket 26. Other manner of connecting the drive sprocket 22 to the driven sprocket 26 may be known to the field of art, such as a drive shaft or fluid drive linkage, and are included within the scope of this disclosure.

The motor 20 may be configured to produce either or both a forward rotational force and a rearward rotational force. The forward rotational force rotating the drive sprocket 22 in a direction that would move wheel 3 in a forward direction when in contact with a surface 7. The rearward rotational force rotating the drive sprocket 22 in a direction that would move the wheel 3 in a rearward direction when in contact with a surface 7.

In an exemplary embodiment, the DU frame 12 may have a handle connector 16. In an exemplary embodiment, handle connector 16 may be configured to securably engage front lift point 5. In an exemplary embodiment, handle connector 16 is a hook structure that may easily be engaged securely to the front lift point 5, while still easily being disengageable from a front lift point 5. In an exemplary embodiment, the DU frame 12 may have an upper connector 14. In an exemplary embodiment, upper connector 14 may be configured to securably engage an upright support 6. In an exemplary embodiment, the upper connector 14 engages with a pair of upright supports 6 to potentially provide superior rotational rigidity to the mounting of the drive unit 10. In an exemplary embodiment, upper connector 14 has a tension adjustment 18 to selectively draw the drive unit 10 closer to the upright support 6. By adjusting the tension adjuster 18, firm contact may be made between the drive wheel 24 and the wheel 3 such that rotation of the drive wheel 24 would impart rotation in the wheel 3. Various forms of tension adjustment 18 are anticipated to be understood by a person having ordinary skill in the art, given this disclosure. In an exemplary embodiment, the tension adjuster 18 enables adjustments to the length of the upper connector 14. By changing the length of upper connector 14, with the handle connector 16 securely engaged with the front lift point 5, the drive unit 10 is pulled closer to the wheel 3, creating greater frictional force between the drive wheel 24 and the wheel 3. Greater frictional force between the drive wheel 24 and the wheel 3 may be seen to increase the capacity of the drive wheel 24 to impart rotation in the wheel 3.

In an exemplary embodiment, a battery receiver 32 may provide a secure attachment point for a removable battery 30. In an exemplary embodiment, the batter receiver 32 may also provide selective electrical connection of the battery 30 to the motor 20. Battery 30 may be a rechargeable battery suitable for use with an cordless tools. It is envisioned that a drive unit 10 may have multiple battery receivers 32 so as to accommodate multiple batteries 30. Adding multiple batteries 30 to the drive unit 10 may provide for additional power to be delivered to the drive wheel 24, which in turn may be transferred to the wheel 3, permitting the wheelbarrow 1 to do greater work. Greater work may include moving a heavier load, propelling the wheelbarrow at faster speed, and enabling the wheelbarrow to operate for a longer period of time before exchanging a battery 30.

In an exemplary embodiment, motor 20 is connected to a control line 40 at connector 42. In an exemplary embodiment, the control line 40 may be an electrical wire and connector 42 may be an electrical connection. In an exemplary embodiment, the distal end of control line 40 may be connected to controller 44. Controller 44 may be configured to have a forward position and a rearward position. Placing the controller 44 in the forward position may cause the drive unit 10 to produce a forward rotational force. Placing the controller 44 in the rearward position may cause the drive unit 10 to produce a rearward rotational force. As such, placing the controller 44 in the forward position may cause the drive unit 10 to move the wheelbarrow 1 in a forward direction. Alternatively, placing the controller 44 in the rearward position may cause the drive unit 10 to move the wheelbarrow 1 in a rearward direction.

In an exemplary embodiment, controller 44 may be a variable control unit that controls the motor power output. In an exemplary embodiment, a variable controller 44 may be a lever, where a greater degree of movement of the lever causes the motor 20 to operate more powerfully. The more powerful operation may result in the ability to move a heavier load or to move a load more quickly. In an exemplary embodiment, control line 40 may be routed up the length of the wheelbarrow to the handles. In an exemplary embodiment, the controller may be mounted at a user interface, which in many cases may be a handle of the wheelbarrow. The wheelbarrow handles are not shown, but those in the field of art for wheelbarrows appreciate that handles may be a standard element.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

### Examples of Potential Claims

Potential claims to the innovation may include a drive unit comprising a frame with an upper attachment and a lower attachment, a drive wheel with a driven sprocket, a drive motor with a drive sprocket, a continuous drive belt to transfer rotational energy from the drive sprocket to the driven sprocket, a battery connection for receiving a standard battery, wherein the frame configured to provide selective frictional contact of the drive wheel to a wheel of a wheelbarrow. The drive unit wherein the frame lower attachment may comprise a hook for selectively secure engagement with a wheelbarrow wheel lift handle, and the frame upper attachment configured to provide selectively secure engagement to the wheelbarrow wheel upright supports.

### Breadth of Disclosure

The foregoing disclosure and description of the invention are illustrative and explanatory thereof. The examples contained in this specification are merely possible implementations of the current device, and alternatives to the particular features and elements may be changed without departing from the spirit of the invention. The present invention should only be limited by the following claims and their legal equivalents, since the provided exemplary embodiments are only examples of how the invention may be employed and are not exhaustive.

I claim:

1. A drive unit for a wheel, the wheel mounted for rotation around an axle in a housing, the wheel having a circumferential working surface intended for contact with a ground surface, the housing having a rear side and a front side corresponding to a rearward and forward direction of the wheel, the rear side having an attachment point at the rear side of a wheel housing and the front side having an attachment point at the rear side of a wheel housing, each attachment point having a set distance from the working surface of the wheel, the drive unit comprising:
a drive unit frame with a first attachment anchor and a second attachment anchor, the first attachment anchor configured to be selectively securable to the rear attachment point, and the second attachment anchor configured to be selectively securable to the front attachment point;
a drive motor operatively connected to a drive wheel supported by the drive unit frame;
the drive wheel mounted to extend from the drive unit frame; and
a battery receiver for receiving a battery, the battery receiver configured to operatively connect a battery to the drive motor.

2. The drive unit of claim 1, further comprising:
the drive wheel mounted in the drive unit frame to provide frictional contact to the working surface of the wheel when the first attachment anchor is secured to the rear attachment point, and the second attachment anchor is secured to the front attachment point.

3. The drive unit of claim 1, further comprising:
the drive unit frame configured to provide selective frictional contact of the drive wheel to the working surface of the wheel.

4. A drive unit for a wheel operatively housed in a frame, comprising:
a drive unit frame housing a drive motor, a drive wheel, and a batter connection;
the drive motor operatively connected to the drive wheel;
the drive wheel extending outward from the drive unit frame to be contactable with a wheel;
the battery receiver for receiving a battery, the battery receiver configured to operatively connect a battery to the drive motor; and
the drive unit frame selectively attachable to the wheel frame with the drive wheel frictionally in contact with the rotational circumference of the wheel.

5. The drive unit of claim 4, further comprising:
the drive unit frame having a wheel frame attachment configured to provide selectively secure engagement to a wheel frame upright supports.

6. The drive unit of claim 5, further comprising:
the wheel frame attachment having a tension adjustment to selectively draw the drive wheel closer to the wheel.

7. The drive unit of claim 4, further comprising:
the drive unit frame having a wheel frame attachment configured to provide selectively secure engagement to a wheel frame front lift point.

8. The drive unit of claim 7, further comprising:
the wheel frame attachment having a tension adjustment to selectively draw the drive wheel closer to the wheel.

9. The drive unit of claim 4, further comprising:
the drive unit frame having a first wheel frame attachment configured to provide selectively secure engagement to a wheel frame upright supports; and
the drive unit frame having a second wheel frame attachment configured to provide selectively secure engagement to a wheel frame front lift point.

10. The drive unit of claim 9, further comprising:
the first wheel frame attachment having a tension adjustment to selectively draw the drive wheel closer to the wheel.

11. The drive unit of claim 9, further comprising:
the second wheel frame attachment having a tension adjustment to selectively draw the drive wheel closer to the wheel.

12. The drive unit of claim 4, further comprising:
the drive wheel adjustably mounted to the drive unit frame to modify the distance the drive wheel extends outward from the drive unit frame to be contactable with a wheel.

13. The drive unit of claim 4, further comprising:
the drive motor operatively connected to the drive wheel by an endless belt.

14. The drive unit of claim 4, further comprising:
the drive motor operatively connected to the drive wheel by a drive shaft.

15. The drive unit of claim 4, further comprising:
the battery receiver configured to receive more than one battery.

16. The drive unit of claim 4, further comprising:
a controller wire operatively connecting the controller to the drive motor, the controller wire having adequate length to reach from the drive motor to a user interface.

17. The drive unit of claim 4, further comprising:
a controller operatively connected to the drive motor, the controller having a forward position wherein the drive unit produces a forward rotational force on the wheel.

18. The drive unit of claim 17, further comprising:
the controller being a variable control unit with a range of motion that controls the motor power output, wherein a greater degree of controller movement causes the drive motor to operate more powerfully.

19. The drive unit of claim 4, further comprising:
a controller operatively connected to the drive motor, the controller having a forward position wherein the drive unit produces a forward rotational force on the wheel and a rearward position wherein the drive unit produces a rearward rotational force on the wheel.

20. The drive unit of claim 19, further comprising:
the controller being a variable control unit with a range of motion that controls the motor power output, wherein a greater degree of controller movement causes the drive motor to operate more powerfully.
